(19) United States
(12) Patent Application Publication
(10) Pub. No.: US 2020/0097026 A1
(43) Pub. Date: Mar. 26, 2020

(54) METHOD, DEVICE, AND SYSTEM FOR ADJUSTING ATTITUDE OF A DEVICE AND COMPUTER-READABLE STORAGE MEDIUM

(71) Applicant: SZ DJI TECHNOLOGY CO., LTD., Shenzhen (CN)

(72) Inventors: Zhuo GUO, Shenzhen (CN); Zhiyuan ZHANG, Shenzhen (CN)

(21) Appl. No.: 16/695,687

(22) Filed: Nov. 26, 2019

Related U.S. Application Data
(63) Continuation of application No. PCT/CN2017/086111, filed on May 26, 2017.

(51) Int. Cl. G05D 1/08; G05D 1/00; G05D 1/06; B64C 39/02; B64D 47/08; H04W 4/029

(52) U.S. Cl. CPC G05D 1/0833; G05D 1/0094; G05D 1/0623; B64C 2201/127; B64D 47/08; H04W 4/029; B64C 39/024

(57) ABSTRACT

A method executable by a first device for instructing a second device to adjust attitude includes determining a first directional vector of the second device relative to the first device. The method also includes transmitting an attitude adjustment instruction to the second device. The attitude adjustment instruction includes directional data indicating the first directional vector or directional data derived based on the first directional vector. The attitude adjustment instruction is configured to instruct the second device to adjust the attitude based on the directional data indicating the first directional vector or the directional data derived based on the first directional vector.

### CROSS-REFERENCE TO RELATED APPLICATION

This application is a continuation application of International Application No. PCT/CN2017/086111, filed on May 26, 2017, the entire content of which is incorporated herein by reference.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### TECHNICAL FIELD

The present disclosure relates to the technology field of automatic control and, more particularly, to a method, a device, and a system for adjusting attitude of a device and computer-readable storage medium.

### BACKGROUND

Unmanned aerial vehicle (“UAV”), also referred to as unmanned aircraft, unmanned aerial system, or other names, is an aircraft that has no human pilot on the aircraft. The flight of the UAV may be controlled through various methods. For example, a human operator (or UAV pilot) may control the UAV remotely. The UAV may also fly semi-automatically or fully-automatically.

When the UAV is remotely controlled, the operator needs to be able to dynamically adjust the flight attitude of the UAV based on actual needs. However, for most ordinary people, the methods of operating a UAV are quite different from the methods of operating a car, a remote-control toy, etc. Therefore, human operators need to take complex and time consuming professional trainings. Accordingly, how to simply the operations of a UAV, and how to make the flight semi-automatic or fully-automatic have become an emerging issue that needs to be addressed.

### SUMMARY

In accordance with the present disclosure, there is provided a method executable by a first device for instructing a second device to adjust attitude. The method includes determining a first directional vector of the second device relative to the first device. The method also includes transmitting an attitude adjustment instruction to the second device. The attitude adjustment instruction includes directional data indicating the first directional vector or directional data derived based on the first directional vector. The attitude adjustment instruction is configured to instruct the second device to adjust the attitude based on the directional data indicating the first directional vector or the directional data derived based on the first directional vector.

In accordance with the present disclosure, there is also provided a first device configured for instructing a second device to adjust attitude. The first device includes a processor and a storage device configured to store instructions. When the instructions are executed by the processor, the instructions cause the processor to perform the following operations: determining a first directional vector of the second device relative to the first device; and transmitting an attitude adjustment instruction to the second device. The attitude adjustment instruction includes directional data indicating the first directional vector or directional data derived based on the first directional vector. The attitude adjustment instruction is configured to instruct the second device to adjust the attitude based on the directional data indicating the first directional vector or the directional data derived based on the first directional vector.

In accordance with the present disclosure, there is also provided a method executable by a second device for adjusting attitude. The method includes receiving an attitude adjustment instruction from a first device. The attitude adjustment instruction includes directional data indicating a first directional vector or directional data derived based on the first directional vector. The first directional vector indicates a directional vector of the second device relative to the first device. The method also includes adjusting the attitude of the second device based on the directional data indicating the first directional vector or the directional data derived based on the first directional vector.

In accordance with the present disclosure, there is also provided a second device configured to adjust attitude. The second device includes a processor and a storage device configured to store computer-readable instructions. When the computer-readable instructions are executed by the processor, the computer-readable instructions cause the processor to perform the following operations: receiving an attitude adjustment instruction from a first device, the attitude adjustment instruction including directional data indicating a first directional vector or directional data derived based on the first directional vector, the first directional vector indicating a directional vector of the second device relative to the first device; and adjusting the attitude of the second device based on the directional data indicating the first directional vector or the directional data derived based on the first directional vector.

### BRIEF DESCRIPTION OF THE DRAWINGS

To better describe the technical solutions of the various embodiments of the present disclosure, the accompanying drawings showing the various embodiments will be briefly described. As a person of ordinary skill in the art would appreciate, the drawings show only some embodiments of the present disclosure. Without departing from the scope of the present disclosure, those having ordinary skills in the art could derive other embodiments and drawings based on the disclosed drawings without inventive efforts.

FIG. 1 is a schematic diagram illustrating an example scene prior to the adjustment of the attitude of a UAV, according to an example embodiment.

FIG. 2 is a user interface for instructing the UAV to adjust attitude, according to an example embodiment.

FIG. 3 is a schematic diagram illustrating an example scene after the adjustment of the attitude of the UAV, according to an example embodiment.

FIG. 4 is a flow chart illustrating a method for instructing a second device to adjust attitude, according to an example embodiment.

FIG. 5 is a schematic diagram of functional modules of a first device for instructing the second device to adjust attitude, according to an example embodiment.

FIG. 6 is a flow chart illustrating a method for adjusting attitude of the second device, according to an example embodiment.

FIG. 7 is a schematic diagram of functional modules of the second device for adjusting the attitude of itself, according to an example embodiment.

FIG. 8 is a schematic diagram of a hardware configuration of a device for adjusting attitude, according to an example embodiment.

It is noted that the accompanying drawings may not be drawn to scale. These drawings are schematically illustrated to the extent that such illustration does not affect the understanding of a reader.

### DETAILED DESCRIPTION OF THE EMBODIMENTS

Technical solutions of the present disclosure will be described in detail with reference to the drawings. It will be appreciated that the described embodiments represent some, rather than all, of the embodiments of the present disclosure. Other embodiments conceived or derived by those having ordinary skills in the art based on the described embodiments without inventive efforts should fall within the scope of the present disclosure.

Example embodiments will be described with reference to the accompanying drawings, in which the same numbers refer to the same or similar elements unless otherwise specified.

Terms such as “first,” “second,” “third,” and “fourth” (if any) used in this specification and the claims are only used to distinguish different objects. These terms do not necessarily describe a specific order or sequence. It should be understood that data modified by such terms may be interchangeable in certain conditions, such that the embodiments described herein may be implemented in an order or sequence different from what is described or illustrated. The terms “including,” “comprising,” and “having” or any other variations are intended to encompass non-exclusive inclusion, such that a process, a method, a system, a product, or a device having a plurality of listed items not only includes these items, but also includes other items that are not listed, or includes items inherent in the process, method, system, product, or device.

As used herein, when a first component (or unit, element, member, part, piece) is referred to as “coupled,” “mounted,” “fixed,” “secured” to or with a second component, it is intended that the first component may be directly coupled, mounted, fixed, or secured to or with the second component, or may be indirectly coupled, mounted, or fixed to or with the second component via another intermediate component. The terms “coupled,” “mounted,” “fixed,” and “secured” do not necessarily imply that a first component is permanently coupled with a second component. The first component may be detachably coupled with the second component when these terms are used. When a first component is referred to as “connected” to or with a second component, it is intended that the first component may be directly connected to or with the second component or may be indirectly connected to or with the second component via an intermediate component. The connection may include mechanical and/or electrical connections. The connection may be permanent or detachable. The electrical connection may be wired or wireless. When a first component is referred to as “disposed,” “located,” or “provided” on a second component, the first component may be directly disposed, located, or provided on the second component or may be indirectly disposed, located, or provided on the second component via an intermediate component. When a first component is referred to as “disposed,” “located,” or “provided” in a second component, the first component may be partially or entirely disposed, located, or provided in, inside, or within the second component.

The terms “perpendicular,” “horizontal,” “vertical,” “left,” “right,” “up,” “upward,” “upwardly,” “down,” “downward,” “downwardly,” and similar expressions used herein are merely intended for description. The term “unit” may encompass hardware and/or software components. For example, a “unit” may include a processor, a portion of a processor, an algorithm, a portion of an algorithm, a circuit, a portion of a circuit, etc. Likewise, the term “module” may encompass hardware and/or software components. For example, a “module” may include a processor, a portion of a processor, an algorithm, a portion of an algorithm, a circuit, a portion of a circuit, etc.

Unless otherwise defined, all the technical and scientific terms used herein have the same or similar meanings as generally understood by one of ordinary skill in the art. As described herein, the terms used in the specification of the present disclosure are intended to describe example embodiments, instead of limiting the present disclosure. The term “and/or” used herein includes any suitable combination of one or more related items listed. The term “communicatively coupled” indicates that related items are coupled or connected through a communication chancel, such as a wired or wireless communication channel.

Further, when an embodiment illustrated in a drawing shows a single element, it is understood that the embodiment may include a plurality of such elements. Likewise, when an embodiment illustrated in a drawing shows a plurality of such elements, it is understood that the embodiment may include only one such element. The number of elements illustrated in the drawing is for illustration purposes only, and should not be construed as limiting the scope of the embodiment. Moreover, unless otherwise noted, the embodiments shown in the drawings are not mutually exclusive, and they may be combined in any suitable manner. For example, elements shown in one embodiment but not another embodiment may nevertheless be included in the other embodiment.

The following descriptions explain example embodiments of the present disclosure, with reference to the accompanying drawings. Unless otherwise noted as having an obvious conflict, the embodiments or features included in various embodiments may be combined.

It should be noted that in the following descriptions, the UAV is used as an example of the control object and a movable terminal is used as an example of the operating entity. However, the present disclosure is not limited to use the UAV and the movable terminal. In some embodiments, the control object may be any suitable control object, such as a robot, a remote-control vehicle, an aircraft, or other devices that may change attitude. In addition, the operating entity may be other devices, such as a non-movable terminal (e.g., a desktop), a remote control device, a handle, a joystick, or any other devices that may transmit operational or control command.

Before describing the embodiments of the present disclosure, certain terminologies used in the following descriptions are defined:

Euler angle/Attitude angle: a relationship between a vehicle body coordinate system and a ground coordinate system may be represented using three Euler angles, which also represent the attitude of the UAV relative to the ground. The three Euler angles are: pitch angle, yaw angle, and roll angle. The vehicle body coordinate system may be represented by three axes in the following three directions: a first direction from the rear portion of the UAV to the head of the UAV, a second direction from the left wing to the right wing, and a third direction that is perpendicular to both of the first direction and the second direction (i.e., perpendicular to a horizontal plane of the UAV) and points to underneath the vehicle body. The ground coordinate system is also referred to as the geodetic coordinate system, and may be represented by three axes in three direction: east, north, and a direction toward the center of the earth.

Pitch angle θ: this is the angle between an X axis (e.g., in a direction from the rear portion of the UAV to the head of the UAV) of the vehicle body coordinate system and a horizontal plane of the ground. When the positive half axis of the X axis is located above a horizontal plane that passes the origin of the coordinate system (e.g., when heading up), the pitch angle is positive; otherwise, the pitch angle is negative. When the pitch angle of the aircraft changes, generally it means the subsequent flight height will change. If the pitch angle of an imaging sensor changes, generally it means a height change will appear in the captured images.

Yaw angle ψ: this is the angle between a projection of the X axis of the vehicle body coordinate system on the horizontal plane and the X axis of the ground coordinate system (which is on the horizontal plane with the pointing direction being positive). When the X axis of the vehicle body coordinate system rotates counter-clockwise to the projection line of the X axis of the ground coordinate system, the yaw angle is positive. That is, when the head of the UAV turns right, the yaw angle is positive; otherwise, the yaw angle is negative. When the yaw angle of the aircraft changes, generally it means a horizontal flight direction in subsequent flight will change. If the yaw angle of the imaging sensor changes, generally it means that left-right movement will appear in the captured images.

Roll angle Φ: this is the angle between the Z axis of the vehicle body coordinate system (e.g., a downward facing direction from a horizontal plane of the UAV) and a vertical plane passing the X axis of the vehicle body. The roll angle is positive when the vehicle body rolls to the right; otherwise, the roll angle is negative. When the roll angle of the aircraft changes, generally it means the horizontal plane rotates. If the roll angle of the imaging sensor changes, generally it means that left tilt or right tilt will appear in the captured images.

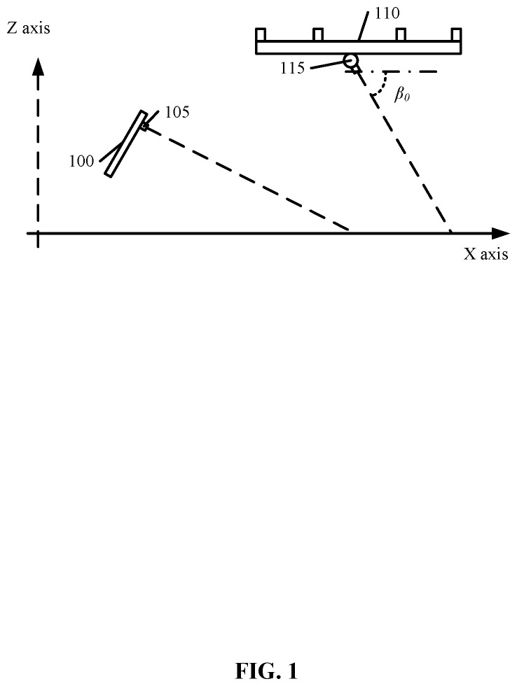

Next, the technical solution of controlling attitude of a UAV 110 (or more generally, a second device) through a movable terminal 100 (or more generally, a first device) will be described in detail with reference to FIG. 1-FIG. 3.

FIG. 1 is an example scene before adjusting the attitude of the UAV 110. As discussed above, one of the objects of the present disclosure is to simplify the operations of the UAV 110, or making the operations semi-automatic or fully-automatic. For example, it has become increasingly popular to control the UAV 110 through the movable terminal 100, such as through a direct Wi-Fi connection or other wireless connections. In some embodiments, the selfie function of the UAV 110 and/or the tracking function may need the UAV 110 or a camera 115 (or more generally, an imaging sensor 115) carried by the UAV 110 to face the movable terminal (or its user). However, when the user needs to adjust the camera 115 of the UAV 110 to face the user, generally the user needs to adjust the attitude of the UAV 110 and/or the attitude (e.g., the yaw angle of the UAV 110, the pitch angle of the gimbal and/or the camera 115 mounted on the UAV 110) of an assembly mounted on the UAV 110 (e.g., a gimbal, the camera 115, etc.) through a joystick of the movable terminal 100 (or any other forms, such as hardware, software, or a combination thereof).

In practice, regardless of whether the user is familiar with the operations of the joystick of the UAV, such operations take a lot of time and energy, and are repetitive and boring. However, such operations have become more and more frequent as the selfie function and/or the tracking function of the UAV 110 become more and more plentiful. Therefore, how to adjust the UAV 110 to quickly face the user has become an emerging issue.

Further, although in some embodiments, the roll angle does not need to be adjusted because of the fact that the UAV 110 is a multi-rotor UAV, in other embodiments, the UAV 110 (or more generally the second device) may be instructed to adjust the roll angle, such that the imaging sensor 115 of the UAV 110 may capture desired images. As shown in FIG. 1, before implementing the technical solution for adjusting attitude of a device, the camera 115 of the UAV 110 is not accurately aiming at the movable terminal 100. It may be assumed that the yaw angle of the camera 115 on the XY plane is α0, and the angle between the XY plane and the horizontal plane is β0 (e.g., the pitch angle). It should be noted that for simplicity, the Y axis of the horizontal plane is not shown in FIG. 1, and the yaw angle α0 is also not shown. However, the Y axis may be described in a manner similar to that is used to describe the X axis. Thus, the description of the Y axis is omitted for simplicity.

As shown in FIG. 1, the UAV 110 is in flight, and the camera 115 mounted on the UAV 110 is not accurately aiming at the movable terminal 100 (or its user). The present disclosure is not limited to such a scene. When the disclosed technical solution is implemented, the UAV 110 may be in other scenes or states, such as in a descending state. In such states, before using the following technical solutions to make the UAV 110 to automatically aim at the user, the UAV 110 may be instructed to automatically take off and hover at a suitable height. Such situations also fall within the scope of the present disclosure. Similarly, when the flight height of the UAV 110 is not sufficient such that adjusting the yaw angle and/or the pitch angle cannot adjust the camera 115 of the UAV 110 to accurately aim at the movable terminal 100, the UAV 110 may automatically increase its height, such that the technical solutions of the present disclosure can be implemented.

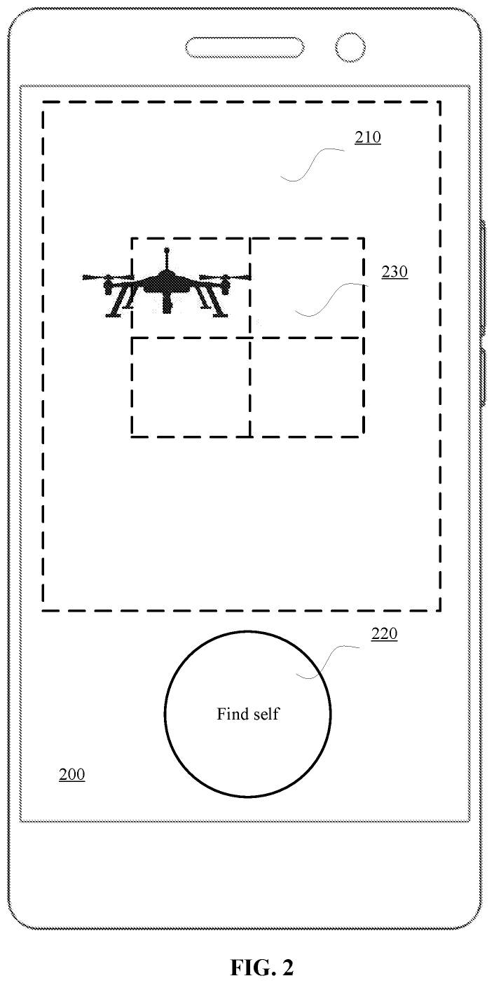

In some embodiments, the camera 115 of the UAV 110 may be instructed to quickly face the user or the movable terminal 100 through an application (or “APP”) installed on the movable terminal 100, within a small error range. In some embodiments, a user interface 200 shown in FIG. 2 may be provided by the APP. As shown in FIG. 2, the user interface 200 may include a main display region 210, a button 220, and an aiming frame 230.

When the APP is started, the user interface 200 may display, in the main display region 210, images captured by the imaging sensor 105 of the movable terminal 100. The imaging sensor 105 may include a rear camera 105 of the movable terminal 100. As such, by observing the images captured by the rear camera 105 that are displayed on the display of the movable terminal 100, the user may determine whether the UAV 110 appears in the images. Of course, the present disclosure is not limited to this. For example, other imaging sensors, such as the front camera, of the movable terminal 100 may be used. In such situations, through the images captured by the front camera, the user may determine whether the UAV 110 appears in the images. In addition, other methods may be used to detect a relationship in the location and/or angle between the movable terminal 100 and the UAV 110. For example, if the movable terminal 100 is provided with a laser distance measurement device, an infrared distance measurement device, an ultrasound sensor, other directional assembly, or an assembly configured to position or locate the UAV 110, the user may use such assemblies to point to the UAV 110 or to locate the UAV 110 using other methods, to realize the an effect similar to using the imaging sensors (e.g., front camera or rear camera 105). In some embodiments, the purpose of the operation of locating the UAV 110 is to obtain a directional vector of the UAV 110 relative to the movable terminal 100. Any suitable method may be used to determine the directional vector, including, but not limited to, using the above various assemblies.

In some embodiments, various smart methods may be used to determine whether the UAV 110 has been located, such as through Wi-Fi, Bluetooth, and broadcasting signals, etc. In some embodiments, if the movable terminal obtains the location information transmitted by the UAV 110, including the coordinates and/or the height, the movable terminal 100 may determine the directional vector based on its own location information and the location information transmitted by the UAV 110. The movable terminal 100 may transmit an attitude adjustment instruction to the UAV 110.

Referring back to FIG. 2, the user may move and/or rotate the movable terminal 100, such that the rear camera 105 of the movable terminal 100 may capture an image of the UAV 110. As shown in FIG. 2, the UAV 110 may appear in the main display region 210 of the user interface 200. In some embodiments, the user may continue to fine-tune a direction of the movable terminal 100 relative to the UAV 110, such that the UAV 110 appears in the aiming frame 230 superimposed on the main display region 210 of the user interface 200. When the user determines that the UAV 110 appears in the aiming frame 230, the user may click the button 220 to notify the movable terminal 100 that the UAV 110 has been located. Although the aiming frame 230 is shown as a square aiming frame in the embodiment of FIG. 2, the present disclosure does not limit the shape of the aiming frame 230. The aiming frame 230 may be any aiming identifier (e.g., a ring shape, a circular shape, a triangular shape, a star shape, etc.). The aiming frame 230 may be used to assist in aiming the rear camera 105 of the movable terminal 100 (e.g., first device) at the UAV 110 (e.g., second device).

In some embodiments, the APP may obtain data related to the current attitude of the movable terminal 100 from other assemblies or devices of the movable terminal 100. For example, the movable terminal 100 may be provided with an accelerometer, a gyroscope, and/or a magnetic sensor to obtain relevant data, which may be used to determine the attitude of the movable terminal 100. The facing direction of the rear camera 105 may be determined based on the attitude of the movable terminal 100. For example, when a directional vector (e.g., a yaw angle and/or a pitch angle) of the movable terminal 100 relative to the geodetic coordinate system is obtained, because the relative location and the facing direction of the rear camera 105 relative to the movable terminal 100 are fixed, the directional vector may indicate a first directional vector (e.g., a yaw angle and/or a pitch angle) of the rear camera 105 of the movable terminal 100 in the geodetic coordinate system. In some embodiments, the first directional vector (e.g., yaw angle and/or pitch angle) of the rear camera 105 of the movable terminal 100 relative to the geodetic coordinate system may be derived based on the directional vector. The yaw angle of the rear camera 105 on the XY plane may be represented by α1, and the angle (i.e., pitch angle) between the XY plane and the horizontal plane may be represented by β1.

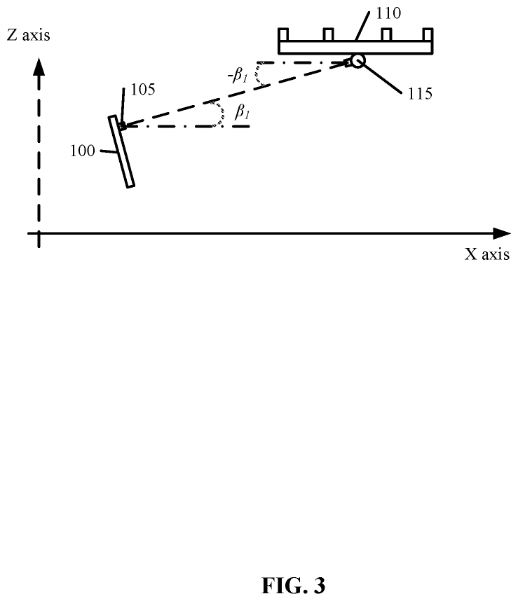

In some embodiments, after the first directional vector is obtained, an attitude adjustment instruction may be transmitted to the UAV 110. The attitude adjustment instruction may include the directional vector (e.g., the first directional vector) or may include another directional vector (e.g., a second directional vector) derived based on the first directional vector. In some embodiments, the second directional vector may be a directional vector that is opposite to the first directional vector, such that the UAV 110 does not need to carry out extra calculations based on the first directional vector. For example, as shown in FIG. 3, the pitch angle component of the second directional vector may be −β1 that is opposite to the pitch angle component β1 of the first directional vector. In some embodiments, the second directional vector may be other directional vectors that may be used to derive the first directional vector, such that the UAV 110 may derive the first directional vector based on the second directional vector, and perform subsequent operations.

In some embodiments, when the UAV 110 receives the attitude adjustment instruction that may include the first directional vector or another directional vector (e.g., the second directional vector) derived based on the first directional vector, a flight control system of the UAV 110 may control the attitude of the UAV 110 and/or the attitude of the imaging sensor 115 carried by the UAV 110 based on the attitude adjustment instruction. For example, the UAV 110 may drive a first propulsion device of the UAV 110 (e.g., one or more motors corresponding to one or multiple rotors), such that the yaw angle of the UAV 110 may change. As such, the UAV 110 may turn its direction as a whole, such that the imaging sensor of the UAV 110 may aim at the movable terminal 100 and/or its user in the plane formed by the X axis and the Y axis of the geodetic coordinate system. For example, the yaw angle may be changed from α0 shown in FIG. 1 to −α1 shown in FIG. 3. In some embodiments, the UAV 110 may drive a second propulsion device (e.g., a motor corresponding to a gimbal on which the imaging sensor 115 of the UAV 110 is mounted), such that the pitch angle of the UAV 110 may be changed. As such, the angle of the imaging sensor 115 may be adjustment, such that the imaging sensor 115 of the UAV 110 may aim at the movable terminal 100 and/or its user in the direction of the Z axis of the geodetic coordinate system. For example, the pitch angle may be changed from (30 shown in FIG. 1 to −β1 shown in FIG. 3.

In some embodiments, as shown in FIG. 3, the UAV 110 may determine its attitude based on at least one of the accelerometer, the gyroscope, and/or the magnetic sensor carried by the UAV 110. The UAV 110 may compare each component of the attitude with a corresponding component of the second directional vector, and may instruct each propulsion device (e.g., motor) of the UAV 110 to operate, thereby adjusting the pointing direction of the imaging sensor 115 of the UAV 110 toward the movable terminal 100 and/or its user. For example, as described above, if there is a difference between the current yaw angle and the yaw angle of the second directional vector, one or more propulsion devices (e.g., one or more motors) may be driven, such that the UAV 110 may rotate in the air to change the yaw angle, in order to make the yaw angle of the imaging sensor 115 of the UAV 110 consistent with the yaw angle of the second directional vector. As another example, as described above, if there is a difference between the current pitch angle of the gimbal and/or the imaging sensor 115 and the pitch angle of the second directional vector, a propulsion device (e.g., motor) of the gimbal and/or the imaging sensor 115 may be driven to adjust the imaging angle of the imaging sensor 115, thereby changing the pitch angle, such that the pitch angle of the imaging sensor 115 is consistent with the pitch angle of the second directional vector.

In some embodiments, although the above descriptions use the rotors of the UAV and the gimbal to adjust the yaw angle and the pitch angle, the present disclosure is not limited to such scenes. In some embodiments, when a three-axis gimbal is used, instead of controlling the rotors of the UAV, only the gimbal may be controlled to adjust the imaging sensor 115 to aim at the movable terminal 100. In some embodiments, when the UAV 110 includes a fixed imaging sensor 115 and when a gimbal is not used, in addition to adjusting the yaw angle of the UAV 110, the pitch angle of the UAV 110 may also be adjusted to indirectly change the pitch angle of the imaging sensor 115, thereby achieving the effect of aiming at the movable terminal 100.

In some embodiments, because the height and/or location of the user do not strictly overlap with those of the movable terminal 100, a predetermined offset amount may be applied to an amount of adjustment for adjusting the attitude of the UAV 110. For example, corresponding components of the first and/or second directional vectors may be adjusted based on a distance between the UAV 110 and the movable terminal 100 (which may be obtained through, e.g., GPS data of the two devices or a distance measurement device of the movable terminal 100, etc.). In some embodiments, a fixed offset amount may be applied to the first and/or second directional vectors. For example, an offset amount may be applied to the pitch angle of the imaging sensor of the UAV 110, such that the imaging sensor of the UAV 110 aims at a location that is above the movable terminal 100 at a fixed distance, rather than aiming at the movable terminal 100 itself. As such, the face of the user may appear, at a better degree, in the images captured by the imaging sensor of the UAV 110.

In some embodiments, the movable terminal 100 (first device) may simultaneously display real time images captured by the imaging sensor 105 of the movable terminal 100 (first device) and real time images captured by the imaging sensor 115 of the UAV 110 (second device), to assist the movable terminal 100 (first device) in locating the UAV 110 (second device) in a more accurate and faster manner. For example, two real time images may be simultaneously displayed side by side, partially overlapped, or picture-in-picture.

As described above with reference to FIG. 1-FIG. 3, in the present disclosure, through simple operations, the imaging sensor 115 of the UAV 110 may be turned to face the movable terminal 100 and to perform actions in corresponding modes. The disclosed method is simple and highly efficient, and can improve user experience. In addition, this function may be extended. For example, in the selfie mode, through this function, the functions of one-button-to-find-self and photo/video may be realized for the UAV 110. In the tracking mode, through this function, the functions of one-button-to-find-self and self-tracking may be realized for the UAV 110.

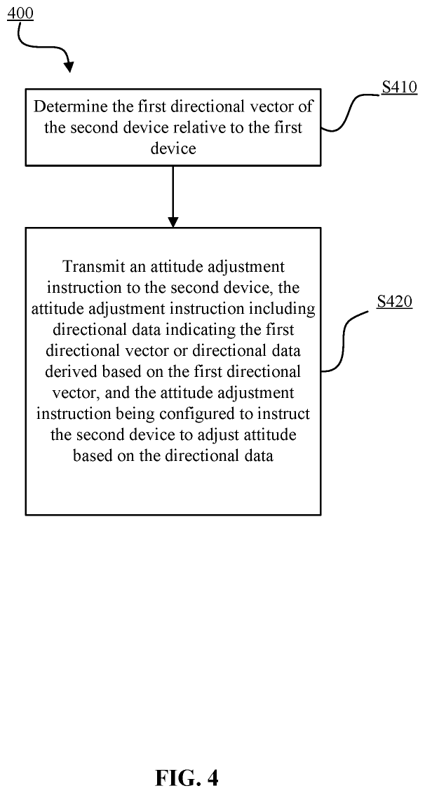

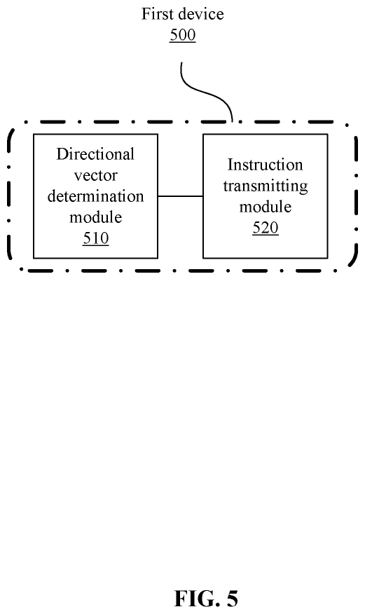

Next, a method executed at a first device 500 for instructing a second device to adjust attitude and the functional structure of the first device will be described with reference to FIG. 4-FIG. 5.

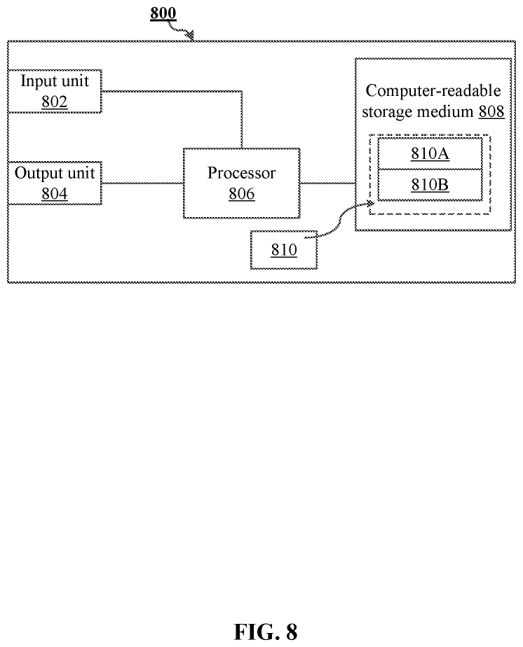

FIG. 4 is a flow chart illustrating a method 400 that may be executed by a first device 500 for instructing a second device to adjust attitude. As shown in FIG. 4, the method 400 may include steps S410 and S420. According to the present disclosure, steps of the method 400 may be independently executed or executed in combination, in parallel or in sequence. The present disclosure does not limit the order of executing the steps to be that shown in FIG. 4. In some embodiments, the method 400 may be executed by the movable terminal 100 shown in FIG. 1 or FIG. 3, the first device 500 shown in FIG. 5, or a device 800 shown in FIG. 8.

FIG. 5 is a schematic diagram of functional modules of a first device 500 (e.g., movable terminal 100). As shown in FIG. 5, the first device 500 may include a directional vector determination module 510 and an instruction transmitting module 520.

In some embodiments, the directional vector determination module 510 may be configured to determine a first directional vector of the second device relative to the first device 500. The directional vector determination module 510 may be a central processing unit, a digital signal processor (“DSP”), a microprocessor, a microcontroller of the first device 500. The directional vector determination module 510 may be coupled with the gyroscope, the magnetic sensor, the accelerometer, and/or the camera of the first device 500 to determine the first directional vector of the second device relative to the first device 500.

In some embodiments, the instruction transmitting module 520 may be configured to transmit an attitude adjustment instruction to the second device. The attitude adjustment instruction may include directional data that may indicate the first directional vector and/or directional data derived based on the first directional vector. The attitude adjustment instruction may be configured to instruct the second device to adjust its attitude based on the directional data. The instruction transmitting module 520 may be a central processing unit, a digital signal processor (“DSP”), a microprocessor, a microcontroller of the first device 500. The instruction transmitting module 520 may be coupled with a communication subsystem of the first device 500 to transmit the attitude adjustment instruction to the second device, such that the second device may accurately aim at the first device 500.

In some embodiments, the first device 500 may include other functional modules or units not shown in FIG. 5. Because such functional modules do not affect the understanding of the disclosed technical solution by a person having ordinary skills in the art, such functional modules are omitted in FIG. 5. For example, the first device 500 may include one or more of the following functional modules: a power source, a storage device, a data bus, an antenna, a wireless signal transceiver, etc.

Next, the method 400 that may be executed by the first device 500 for instructing the second device to adjust attitude and the first device 500 will be described in detail with reference to FIG. 4 and FIG. 5.

Method 400 may start with step S410. In step S410, the directional vector determination module 510 of the first device 500 may determine the first directional vector of the second device relative to the first device 500.

In step S420, the instruction transmitting module 520 of the first device 500 may transmit the attitude adjustment instruction to the second device. The attitude adjustment instruction may include directional data indicating the first directional vector or directional data derived based on the first directional vector. The attitude adjustment instruction may be configured to instruct the second device to adjust the attitude based on the directional data indicating the first directional vector or the directional data derived based on the first directional vector.

In some embodiments, step S410 may include: locating the second device; determining locating attitude of the first device 500 when the first device 500 locates the second device; and determining the first directional vector of the second device relative to the first device 500 based on the locating attitude of the first device 500. In some embodiments, locating the second device may include: locating the second device based on the imaging sensor of the first device 500. In some embodiments, the imaging sensor of the first device 500 may include the rear camera of the first device 500. In some embodiments, locating the second device based on the imaging sensor of the first device 500 may include: determining whether the second device is located by determining whether the second device appears in an image captured by the imaging sensor. In some embodiments, the locating attitude of the first device 500 may be determined based on at least one of the following devices included in the first device 500: an accelerometer, a gyroscope, or a magnetic sensor. In some embodiments, determining the first directional vector of the second device relative to the first device 500 based on the locating attitude of the first device 500 may include: determining locating attitude of the imaging sensor of the first device 500 based on the locating attitude of the first device 500; and determining a directional vector of an optical center axis of the imaging sensor based on the locating attitude of the imaging sensor, and determining (or using) the directional vector as the first directional vector of the second device relative to the first device 500. In some embodiments, directional data derived based on the first directional vector may include directional data indicating the second directional vector that is opposite to the first directional vector.

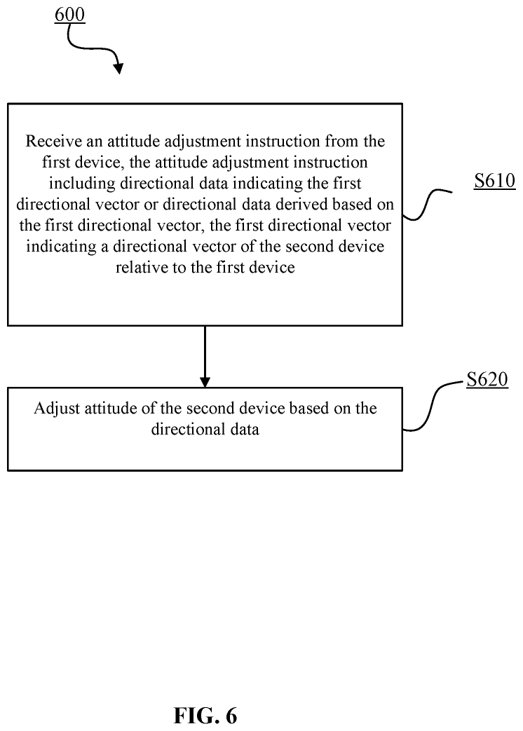

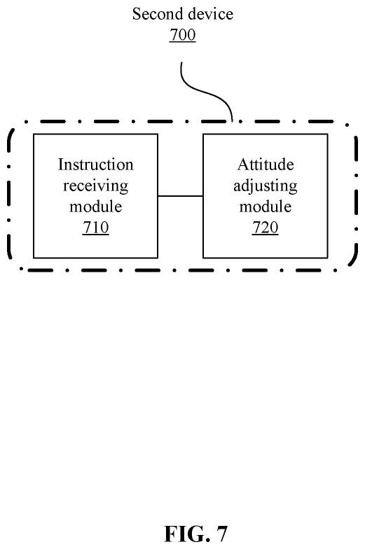

Next, a method 600 that may be executed by a second device 700 (e.g., UAV 110) for adjusting attitude and functional structures of the second device 700 will be described in detail with reference to FIG. 6-FIG. 7.

FIG. 6 is a flow chart illustrating the method 600 that may be executed by the second device 700 for adjusting attitude. As shown in FIG. 6, the method 600 may include steps S610 and S620. Steps of the method 600 may be executed independently or in combination, in parallel or in sequence. The present disclosure does not limit the order in which the steps are executed. In some embodiments, the method 600 may be executed by the UAV shown in FIG. 1 or FIG. 3, the second device 700 shown in FIG. 7, or the device 800 shown in FIG. 8.

FIG. 7 is a schematic diagram of functional modules of the second device 700 (e.g., the UAV 110). As shown in FIG. 7, the second device 700 may include: an instruction receiving module 710 and an attitude adjusting module 720.

The instruction receiving module 710 may be configured to receive an attitude adjustment instruction from the first device 500. The attitude adjustment instruction may include directional data indicating the first directional vector or directional data derived based on the first directional vector. The first directional vector may indicate a directional vector of the second device 700 relative to the first device 500. The instruction receiving module 710 may be a central processing unit, a digital signal processor (“DSP”), a microprocessor, a microcontroller of the second device 700. The instruction receiving module 710 may be configured to couple with a communication module of the second device 700 to receive the attitude adjustment instruction from the first device 500 and the directional data included in the attitude adjustment instruction.

In some embodiments, the attitude adjusting module 720 may be configured to adjust the attitude of the second device 700 based on the directional data. The attitude adjusting module 720 may be a central processing unit, a digital signal processor (“DSP”), a microprocessor, or a microcontroller of the second device 700. The attitude adjusting module 720 may be coupled with the motor of the second device. The attitude adjusting module 720 may be configured to adjust the attitude of the second device to be consistent with the aiming direction indicated by the directional vector based on the attitude data provided by at least one of the accelerometer, gyroscope, or magnetic sensor of the second device 700.

In some embodiments, the second device 700 may include other functional modules not shown in FIG. 7. Because these functional modules do not affect the understanding of the disclosed technical solutions by a person having ordinary skills in the art, they are omitted from

FIG. 7. For example, the second device 700 may include one or more of the following functional modules: a power source, a storage device, a data bus, an antenna, a wireless transceiver, etc.

Next, the method 600 that may be executed by the second device 700 for adjusting the attitude and the structure and functions of the second device 700 will be described in detail with reference to FIG. 6-FIG. 7.

The method 600 may start with step S610. In step S610, the instruction receiving module 710 of the second device 700 may receive an attitude adjustment instruction from the first device 500. The attitude adjustment instruction may include directional data indicating the first directional vector or directional data derived based on the first directional vector. The first directional vector may indicate a directional vector of the second device 700 relative to the first device 500.

In step S620, the attitude adjusting module 720 of the second device 700 may adjust the attitude of the second device 700 based on the directional data indicating the first directional vector or the directional data derived based on the first directional vector.

In some embodiments, the directional data derived based on the first directional vector may include directional data of a second directional vector that is opposite to the first directional vector. In some embodiments, the step S620 may include: adjusting the attitude of the second device 700 based on the second directional vector. In some embodiments, adjusting the attitude of the second device 700 based on the second directional vector may include: driving a propulsion device of the second device such that a facing direction of a first assembly of the second device 700 is consistent with the second directional vector. In some embodiments, the first assembly may include at least an imaging sensor of the second device 700. In some embodiments, driving the propulsion device of the second device 700 such that the facing direction of the first assembly of the second device 700 is consistent with the second directional vector may include: driving a first propulsion device of the second device 700, such that the yaw angle of the second device 700 is consistent with a corresponding component of the second directional vector; and driving a second propulsion device of the second device 700 such that the pitch angle of the first assembly of the second device 700 is consistent with the corresponding component of the second directional vector.

FIG. 8 is a schematic diagram of a hardware configuration 800 of the first device 500 shown in FIG. 5 or the second device 700 shown in FIG. 7 (hence the hardware configuration 800 may also be referred to as a device 800). The hardware configuration 800 may include a processor 806 (e.g., a central processing unit (“CPU”), a digital signal processor (“DSP”), a microcontroller unit (“MCU”), etc.). The processor 806 may be a single processing unit or multiple processing units configured to perform various operations of the processes or methods disclosed herein. The configuration 800 may include an input unit 802 configured to receive signals from other physical entities, an output unit 804 configured to output signals to other physical entities. The input unit 802 and the output unit 804 may be configured as a single physical entity or separate physical entities.

In some embodiments, the configuration 800 may include at least one non-transitory computer-readable storage medium 808, which may include a non-volatile or a volatile storage device. For example, the computer-readable storage medium 808 may include an Electrically Erasable Programmable read only memory (“EEPROM”), a flash memory, and/or a hard disk. The computer-readable storage medium 808 may include computer program instructions 810. The computer program instructions 810 may include codes and/or computer-readable instructions. The codes and/or computer-readable instructions, when executed by the processor 806 of the configuration 800, may cause the hardware configuration 800 and/or the first device 500 or the second device 700 including the hardware configuration 800 to execute the processes or methods shown in FIG. 4 or FIG. 6, and other variations of the processes or methods.

In some embodiments, the computer program instructions 810 may be configured to be computer program instruction codes that include instruction modules 810A-810B. In some embodiments, when the first device 500 includes the hardware configuration 800, the codes in the computer program instructions of the configuration 800 may include: module 810A configured to determine the first directional vector of the second device 700 relative to the first device 500. The codes in the computer program instructions may include: module 810B configured to transmit an attitude adjustment instruction to the second device 700. The attitude adjustment instruction may include directional data indicating the first directional vector or directional data derived based on the first directional vector. The attitude adjustment instruction may instruct the second device 700 to adjust attitude of the second device 700 based on the directional data.

In some embodiments, when the second device 700 includes the hardware configuration 800, the codes included in the computer program instructions of the hardware configuration 800 may include: module 810A configured to receive an attitude adjustment instruction from the first device 500. The attitude adjustment instruction may include directional data indicating the first directional vector or directional data derived based on the first directional vector. The first directional vector may indicate a directional vector of the second device 700 relative to the first device 500. The codes in the computer program instructions may include: module 810B configured to adjust the attitude of the second device 700 based on the directional data.

In some embodiments, the modules of the computer program instructions may be configured to execute the various operations included in the processes or methods shown in FIG. 4 or FIG. 6, to simulate the first device 500 or the second device 700. In some embodiments, when the processor 806 executes different modules of the computer program instructions, the modules may correspond to different operations of the first device 500 or the second device 700.

Although forms of codes implemented in the embodiment shown in FIG. 8 are described as modules of the computer program instructions, which when executed by the processor 806, cause the hardware configuration 800 to perform the various operations of the processes or methods shown in FIG. 4 or FIG. 6, in other embodiments, at least one of the forms of codes may be partially realized using a hardware circuit.

In some embodiments, the processor may be a single CPU, or may be two or more CPUs. For example, the processor may include a generic microprocessor, an instruction set processor, and/or related chips assembly, and/or dedicated microprocessor (e.g., application-specific integrated circuit (“ASIC”)). The processor may include an on-board storage device configured to perform as a buffer. The computer program instructions may be loaded onto a computer program instruction product connected with the processor. The computer program instruction product may include the computer-readable medium that stores the computer program instructions. For example, the computer program instruction product may include a flash memory, a random-access memory (“RAM”), a read-only memory (“ROM”), an EEPROM. The modules of the computer program instructions may be distributed to different computer program instruction products in the form of a storage device included in user equipment (“UE”).

In some embodiments, the functions realized through hardware, software, and/or firmware, as described above, may also be realized through dedicated hardware, or a combination of generic hardware and software. For example, functions described as being realized through dedicated hardware (e.g., a field-programmable gate array (“FPGA”), ASIC, etc.) may also be realized through a combination of generic hardware (e.g., CPU, DSP, etc.) and software, and vice versa.

A person having ordinary skill in the art can appreciate that part or all of the above disclosed methods and processes may be implemented using related electrical hardware, computer software, or a combination of electrical hardware and computer software that may control the electrical hardware. To illustrate the exchangeability of the hardware and software, in the above descriptions, the configurations and steps of the various embodiments have been explained based on the functions performed by the hardware and/or software. Whether the implementation of the functions is through hardware or software is to be determined based on specific application and design constraints. A person having ordinary skill in the art may use different methods to implement the functions for different applications. Such implementations do not fall outside of the scope of the present disclosure.

A person having ordinary skill in the art can appreciate that the various system, device, and method illustrated in the example embodiments may be implemented in other ways. For example, the disclosed embodiments for the device are for illustrative purpose only. Any division of the units are logic divisions. Actual implementation may use other division methods. For example, multiple units or components may be combined, or may be integrated into another system, or some features may be omitted or not executed. Further, couplings, direct couplings, or communication connections may be implemented using indirect coupling or communication between various interfaces, devices, or units. The indirect couplings or communication connections between interfaces, devices, or units may be electrical, mechanical, or any other suitable type.

In the descriptions, when a unit or component is described as a separate unit or component, the separation may or may not be physical separation. The unit or component may or may not be a physical unit or component. The separate units or components may be located at a same place, or may be distributed at various nodes of a grid or network. Some or all of the units or components may be selected to implement the disclosed embodiments based on the actual needs of different applications.

Various functional units or components may be integrated in a single processing unit, or may exist as separate physical units or components. In some embodiments, two or more units or components may be integrated in a single unit or component.

If the integrated units are realized as software functional units and sold or used as independent products, the integrated units may be stored in a computer-readable storage medium. Based on such understanding, the portion of the technical solution of the present disclosure that contributes to the current technology, or some or all of the disclosed technical solution may be implemented as a software product. The computer software product may be storage in a non-transitory storage medium, including instructions or codes for causing a computing device (e.g., personal computer, server, or network device, etc.) to execute some or all of the steps of the disclosed methods. The storage medium may include any suitable medium that can store program codes or instruction, such as at least one of a U disk (e.g., flash memory disk), a movable hard disk, a read-only memory (“ROM”), a random access memory (“RAM”), a magnetic disk, or an optical disc.

The above descriptions only illustrate some embodiments of the present disclosure. The present disclosure is not limited the described embodiments. A person having ordinary skill in the art may conceive various equivalent modifications or replacements based on the disclosed technology. Such modification or improvement also fall within the scope of the present disclosure. A true scope and spirit of the present disclosure are indicated by the following claims.

What is claimed is:

1. A method executable by a first device for instructing a second device to adjust attitude, comprising:
determining a first directional vector of the second device relative to the first device; and
transmitting an attitude adjustment instruction to the second device, the attitude adjustment instruction comprising directional data indicating the first directional vector or directional data derived based on the first directional vector, and the attitude adjustment instruction being configured to instruct the second device to adjust the attitude based on the directional data indicating the first directional vector or the directional data derived based on the first directional vector.

2. The method of claim 1, wherein determining the first directional vector of the second device relative to the first device comprises:
locating the second device;
determining locating attitude of the first device when the first device locates the second device; and
determining the first directional vector of the second device relative to the first device based on the locating attitude of the first device.

3. The method of claim 2, wherein locating the second device comprises:
locating the second device based on an imaging sensor of the first device.

4. The method of claim 3, wherein the imaging sensor includes a rear camera of the first device.

5. The method of claim 4, wherein locating the second device based on the imaging sensor of the first device comprises:
determining whether the second device is located by determining whether the second device appears in an image captured by the imaging sensor.

6. The method of claim 5, further comprising displaying an aiming identifier in the image captured by the imaging sensor of the first device.

7. The method of claim 5, wherein the second device also includes an imaging sensor, and the method further comprises displaying, by the first device, real time images captured by the imaging sensor of the first device and the imaging sensor of the second device.

8. The method of claim 2, further comprising determining the locating attitude of the first device based on at least one of an accelerometer, a gyroscope, or a magnetic sensor.

9. The method of claim 3, wherein determining the first directional vector of the second device relative to the first device based on the locating attitude of the first device comprises:
determining locating attitude of the imaging sensor of the first device based on the locating attitude of the first device; and
determining a directional vector of an optical center axis of the imaging sensor based on the locating attitude of the imaging sensor, and using the determined directional vector as the first directional vector of the second device relative to the first device.

10. The method of claim 1, wherein the directional data derived based on the first directional vector comprise directional data of a second directional vector opposite to the first directional vector.

11. A first device configured for instructing a second device to adjust attitude, the first device comprising:
a processor;
a storage device configured to store instructions, wherein when the instructions are executed by the processor, the instructions cause the processor to perform the following operations:
determining a first directional vector of the second device relative to the first device; and
transmitting an attitude adjustment instruction to the second device, the attitude adjustment instruction comprising directional data indicating the first directional vector or directional data derived based on the first directional vector, the attitude adjustment instruction configured to instruct the second device to adjust the attitude based on the directional data indicating the first directional vector or the directional data derived based on the first directional vector.

12. The first device of claim 11, wherein when the instructions are executed by the processor, the instructions cause the processor to perform the following operations:
locating the second device;
determining locating attitude of the first device when the first device locates the second device; and
determining the first directional vector of the second device relative to the first device based on the locating attitude of the first device.

13. The first device of claim 11, further comprising an imaging sensor, and wherein when the instructions are executed by the processor, the instructions cause the processor to perform the following operation:
locating the second device through the imaging sensor of the first device.

14. The first device of claim 13, wherein the imaging sensor is a rear camera of the first device.

15. The first device of claim 13, further comprising a display, wherein when the instructions are executed by the processor, the instructions cause the processor to perform the following operation:
determining whether the second device is located by determining whether the second device appears in an image captured by the imaging sensor and displayed by the display.

16. The first device of claim 15, wherein when the instructions are executed by the processor, the instructions cause the processor to perform the following operation:
displaying, by the display, an aiming identifier in the image captured by the imaging sensor.

17. The first device of claim 15, wherein the second device also includes an imaging sensor, and wherein when the instructions are executed by the processor, the instructions cause the processor to perform the following operation:
simultaneously displaying, by the display, real time images captured by the imaging sensor of the first device and the imaging sensor of the second device.

18. The first device of claim 12, further comprising at least one of an accelerometer, a gyroscope, or a magnetic sensor, and wherein the locating attitude of the first device is obtained through at least one of the accelerometer, the gyroscope, or the magnetic sensor.

19. The first device of claim 13, wherein when the instructions are executed by the processor, the instructions cause the processor to perform the following operations:
determining locating attitude of the imaging sensor of the first device based on locating attitude of the first device; and
determining a directional vector of an optical center axis of the imaging sensor based on the locating attitude of the imaging sensor, and using the directional vector as the first directional vector of the second device relative to the first device.

20. The first device of claim 11, wherein the directional data derived based on the first directional vector comprise directional data of a second directional vector that is opposite to the first directional vector.

21. A method executable by a second device for adjusting attitude, comprising:
receiving an attitude adjustment instruction from a first device, the attitude adjustment instruction comprising directional data indicating a first directional vector or directional data derived based on the first directional vector, the first directional vector indicating a directional vector of the second device relative to the first device; and
adjusting the attitude of the second device based on the directional data indicating the first directional vector or the directional data derived based on the first directional vector.

22. The method of claim 21, wherein the directional data derived based on the first directional vector comprise directional data of a second directional vector that is opposite to the first directional vector.

23. The method of claim 22, wherein adjusting the attitude of the second device based on the directional data indicating the first directional vector or the directional data derived based on the first directional vector comprises:
adjusting the attitude of the second device based on the second directional vector.

24. The method of claim 23, wherein adjusting the attitude of the second device based on the second directional vector comprises:
driving a propulsion device of the second device to adjust a facing direction of a first assembly of the second device to be consistent with the second directional vector.

25. The method of claim 24, wherein the first assembly comprises at least an imaging sensor of the second device.

26. The method of claim 24, wherein driving the propulsion device of the second device to adjust the facing direction of the first assembly of the second device to be consistent with the second directional vector comprises:
driving a first propulsion device of the second device to adjust a yaw angle of the second device to be consistent with a corresponding component of the second directional vector; and
driving a second propulsion device of the second device to adjust a pitch angle of the first assembly of the second device to be consistent with a corresponding component of the second directional vector.

27. A second device configured to adjust attitude, comprising:
a processor;
a storage device configured to store computer-readable instructions, wherein when the computer-readable instructions are executed by the processor, the computer-readable instructions cause the processor to perform the following operations:
receiving an attitude adjustment instruction from a first device, the attitude adjustment instruction comprising directional data indicating a first directional vector or directional data derived based on the first directional vector, the first directional vector indicating a directional vector of the second device relative to the first device; and
adjusting the attitude of the second device based on the directional data indicating the first directional vector or the directional data derived based on the first directional vector.

28. The second device of claim 27, wherein the directional data derived based on the first directional vector comprise directional data of a second directional vector that is opposite to the first directional vector.

29. The second device of claim 28, wherein when the computer-readable instructions are executed by the processor, the computer-readable instructions cause the processor to perform the following operation:
adjusting the attitude of the second device based on the second directional vector.

30. The second device of claim 29, wherein when the computer-readable instructions are executed by the processor, the computer-readable instructions cause the processor to perform the following operation:
driving a motor of the second device to adjust a facing direction of a first assembly of the second device to be consistent with the second directional vector.

31. The second device of claim 30, wherein the first assembly comprises at least an imaging sensor of the second device.

32. The second device of claim 29, wherein when the computer-readable instructions are executed by the processor, the computer-readable instructions cause the processor to perform the following operations:
driving a first motor of the second device to adjust a yaw angle of the second device to be consistent with a corresponding component of the second directional vector; and
driving a second motor of the second device to adjust a pitch angle of a first assembly of the second device to be consistent with a corresponding component of the second directional vector.
